(19) United States
(12) Patent Application Publication
(10) Pub. No.: US 2006/0177291 A1
(43) Pub. Date: Aug. 10, 2006

(54) Identification system for identifying objects

(75) Inventors: Katja Kienzl, Graz (AT); Matthias Weitlaner, Lieboch (AT)

Correspondence Address: DICKSTEIN SHAPIRO MORIN & OSHINSKY LLP., 1177 AVENUE OF THE AMERICAS 6TH AVENUE, NEW YORK, NY, 10036-1400, US

(73) Assignee: Infineon Technologies AG, Munich (DE)

(21) Appl. No.: 11/283,539

(22) Filed: Nov. 18, 2005

(30) Foreign Application Priority Data
Nov. 19, 2004 (DE) 10 2004 055 931.7

(51) Int. Cl. B65G 1/00

(52) U.S. Cl. 414/331.15

(57) ABSTRACT

A system for identifying objects with high reliability contains a transmitting part which is fitted to the respective object to be identified and can transmit a code radio frequency signal. The system further includes an activation part which can transmit an activation radio frequency signal to the transmitting part of a respective object which is moving past the activation part in order to cause the transmitting part to transmit the code radio frequency signal. The system also includes a receiving part which can receive the respective code radio frequency signa and a variation device which can vary the distance between successive objects and/or relative alignment between an electromagnetic field which is produced and the object moving past.

### CROSS-REFERENCE TO RELATED APPLICATION

This application claims priority to German Patent Application Serial No. 10 2004 055 931.7, which was filed on Nov. 19, 2004, and is incorporated herein by reference in its entirety.

### FIELD OF THE INVENTION

The invention relates to an identification system for the identification of objects, in particular of objects which are conveyed continuously, such as items of clothing in sorting installations.

### BACKGROUND OF THE INVENTION

In order to allow the transportation and dispatch of large numbers of articles to be carried out more quickly and at low cost, it is advantageous to identify the respective objects to be transported in the associated logistics system automatically and to allocate them to the correct distribution and dispatch points automatically based on this automatic identification, and to transport or to dispatch them further in an appropriate manner.

WO 2004/082153 A2 describes a system for routing of a support on a moving transport system which has a plurality of distribution points and at least one support. Each support has a tag which can be read electronically and is coupled to the support, and each tag has a specific identifier, which can be read. A reading device is designed to read the tag which can be read electronically and to transmit the identifier on the tag to a control device. The control device is in turn designed to control at least one distribution station in the moving transport system, at least partially based on the identifier.

DE 44 23 082 C2 describes a method and an installation for sorting parts which are in a closed circuit. The sorting process starts by the production of groups from parts which are located in the circuit and have been identified by a code reading device as being associated. The groups formed are moved out of the circuit and are collected in a sorting buffer. The groups are then immediately sent back into the circuit. The parts within a group are sorted by moving a part out of each group as the group moves past the sorting buffer, and by moving the respective part back into the group at the correct point within the group. Parts which arrive later are moved into the correct point in the group from the moving-in station as the group passes by.

DE 40 28 388 A1 describes a method and an apparatus for the identification of items of clothing which are conveyed in a hanging form while being transported. In the case of the method, the items of clothing, which are transported on a conveyor path and provided with an identification code, pass separately through a measurement path, which is included in the conveyor path, and are identified and weighed on this measurement path. The detected identification code and the determined weight of the item of clothing are transmitted to a computer, which contains a predetermined table with identification and weight data, for checking, and the item of clothing is then transported onwards if the values are correct, or is moved out if the values are incorrect.

### SUMMARY OF THE INVENTION

The invention provides an identification system for identification of objects, by means of which objects can be identified in a simple, quick and nevertheless very reliable manner.

The identification system according to the invention for identification of objects for this purpose has: a transmitting part which is fitted to the respective object to be identified and which can transmit a code radio frequency signal which represents an identification code, an activation part which can transmit an activation radio frequency signal via a wire-free connection to the transmitting part of a respective object as it moves past the activation part in order to cause the transmitting part to transmit the code radio frequency signal, a receiving part which can receive the respective code radio frequency signal via a wire-free connection, and a variation device which is arranged adjacent to the activation part and can vary the distance between objects moving successively past the activation part and/or relative alignment between the electromagnetic field which defines the activation radio frequency signal and the respective object moving past the activation part.

In particular, conventional passive or active transponders in the form, for example, of disks or coins or other solid physical forms are provided as the transmitting part, having a coil which is encapsulated in an appropriately shaped plastic housing and acts as a receiving antenna for reception of the activation radio frequency signal originating from the activation part, and as a transmission antenna for transmission of the code radio frequency signal. It is also possible to provide transponder forms which are as thin as paper and in which the transponder coil is applied, for example, by screen printing or by means of an etching technique, to a plastic film which is very thin and in particular has a thickness of no more than 0.1 mm. The latter are known as so-called “smart labels”.

The activation part is preferably a conventional transmitter/reader using Radio Frequency Identification (RFID) technology which, in particular, operates in the radio frequency range from 3 to 30 MHz, although appropriate different wavelengths, such as low frequency from 30 kHz to 300 kHz, ultra-high frequency from 300 MHz to 3 GHz or microwave frequencies above 3 GHz may also be used depending on the desired range, which is preferably between 1 and 10 m. The associated transmitting part operates at an appropriate frequency for the activation part.

It is particularly preferable to provide a passive transmitting part which receives its electrical operating energy via the activation radio frequency signal which, in addition, also has the activation information which stimulates the transmitting part to transmit the code associated with this.

Use of an RFID system such as this fundamentally offers the advantage that the respective activation part need not be in uninterrupted visual contact with the associated transmitting part as is the case, for example, with a barcode system. The object can thus be moved past the activation part with a certain amount of variability in terms of its distance and its alignment, in order to be reliably identified.

In this case, the activation part continuously transmits activation information in the form of the activation radio frequency signal over a specific area, and the activation radio frequency signal then causes a transmitting part, which is passing through this electromagnetic field but otherwise does not transmit any radio signals, to be stimulated, as explained above. A memory apparatus, in particular in the form of a microchip (preferably having a memory and a microprocessor) is provided in the transmitting part and stores in its memory code information which preferably unambiguously identifies the transmitting part and is then transmitted by the activation radio frequency signal in the form of the code radio frequency signal that has been mentioned, following stimulation of the transmitting part.

In addition to the preferred passive transmitting part type, the transmitting part may also be designed in active form, in which case it then has a battery from which it receives the electrical operating energy required for transmission. In this case, the received activation radio frequency signal is used in particular for addressing purposes, to wake up and thus to activate the transmitting part.

The transmitted code radio frequency signal is received by the receiving part which, in particular, is arranged adjacent to the activation part, for example by being arranged opposite it. The activation part and the receiving part may be provided in one unit, with the two being connected to a control apparatus, such as a microprocessor, which produces, processes and evaluates the respective transmitted/received frequency signals.

The activation part and the receiving part may, for example, be mutually opposite antennas, so-called gate antennas, with one antenna being provided exclusively for transmission of the activation radio frequency signal, and the other antenna being provided for reception of the code radio frequency signal. This allows the system to be operated using the half-multiplex or full-multiplex process, in which energy can be transmitted all the time via the activation part to the transmitting part, and activation radio frequency signals can be transmitted to the transmitting part, with code radio frequency signals being transmitted from the transmitting part to the receiving part, such that they overlap sequentially. It is also possible for the activation part and the receiving part to be in the form of a single unit, for example, to be provided in the form of a single antenna, in which case only sequential operation of the identification system is then possible, that is to say the activation part transmits energy together with the activation radio frequency signal in the direction of the transmitting part, in response to which the activation part is then switched to receive, in which state it then acts only as a receiving part and can receive only code radio frequency signals transmitted from the transmitting part, though there is no longer any energy transmission or activation radio frequency signal transmission in the direction of the transmitting part.

The activation part and the receiving part thus together form an identification apparatus for the system.

In order to preclude a situation, when either the objects to be identified are arranged too close to one another and/or if the transmitting part is aligned so disadvantageously with respect to the activation part that the transmitting part does not receive the activation radio frequency signal originating from the activation part in a reasonable form for sufficient electromagnetic stimulus, that is to say that the transmitting part is not stimulated and is thus not caused to transmit its code radio frequency signal, the identification system additionally has a variation device which can move the objects moving past the activation part in such a way that their distance from one another in the movement direction is changed. In particular, the distance is increased. Alternatively, their alignment is changed, hence also changing the alignment of the transmitting part arranged in them relative to the activation part, and thus relative to the alignment of the electromagnetic field originating from it.

This makes it possible to achieve even greater reliability in terms of reliable activation of the transmitting parts and reliable identification of the signals transmitted from the transmitting parts, since the probability of achieving a relative alignment as required for a correct radio connection between the transmitting part and the activation and receiving part, and/or a sufficient distance between successive transmitting parts is greatly increased.

The variation device can move the respective objects or the activation parts deliberately in a controlled manner. In particular, however, arbitrary movements of the transported objects are also envisaged, for which purpose the variation device can be provided in a particularly simple and thus low-cost manner, as will be seen from the following description.

For example, in the case of a logistics system having objects which are to be transported and are provided with a respective transmitting part, such as medication bags, are packaged in a relatively loose arrangement in larger boxes, with the larger box then being placed in the area of the activation part or of the receiving part, that is to say the identification apparatus, on a shaking apparatus which is used as the variation device, which moves the large box such that it is arbitrarily lightly shaken. This results in the smaller bags located therein being moved to different arbitrary positions. This process takes place within the operating area of the activation part and transmitting part, so that this arbitrarily results in the desired distance changes and alignment changes, and sufficiently increases the probability of all transmitting parts being detected correctly by the identification apparatus.

By way of example, a tumbler disk, on which the box is positioned, can be provided as the shaking apparatus.

The identification system is preferably equipped with a transport apparatus, advantageously a continuous conveyor installation, such as a conveyor belt installation or an overhead conveyor installation, which automatically moves the respective objects past the activation part and the receiving part which is adjacent to it.

In this case, the variation device is designed such that the transported objects are moved to a minimum separation from one another or to a distance from one another which is greater than the minimum separation. The minimum separation is determined based upon the minimum permissible distance resolution for correct detection of code radio frequency signals from adjacent objects. The distance resolution is a known resolution which is a characteristic of the activation part and of the receiving part and indicates the minimum separation between mutually adjacent transmitting parts which can still be distinguished from one another by the identification apparatus.

The variation device may be a motor-powered stopper arm in an overhead conveyor or in a belt conveyor, which is positioned upstream of the activation part in the movement direction of the objects and stops the movement of the respective object on the conveyor if the distance between the respective object and the previous object is less than the minimum separation. The monitoring of the minimum separation can be carried out by a sensor, such as a camera, which is connected to a control apparatus which is itself connected to the motor drive driving the stopper arm, such that it is possible to intervene in the transport traffic in a controlled manner. In this case, the objects may be transported by a sliding clutch which allows the conveyor part to slide forwards with respect to the object as a result of overloading produced by the stopper arm. It is also feasible to provide a switch with a stop or bypass path as a variation device such as this, via which objects which are following one another too closely are moved away from the transport path and are then moved back into the transport path again after an appropriate time delay.

A variation device which is simpler and is thus preferable for cost reasons is formed by a movement apparatus which engages transversely in the transport path in order to move the objects arbitrarily moving past it in an essentially uncontrolled manner.

In the case of an overhead conveyor, this can be achieved for example by providing some form of obstruction such as a flexible bar, a cord arrangement, or a cord which is stretched transversely over the transport path, which directly or indirectly, for example by a hanger which hangs down from the conveyor system, impedes the moving objects and thus causes them to swing. The objects which have been mechanically stimulated in this way thus move in a swinging movement past the activation part, thus resulting in the transmitting parts which are fitted to them also being at different distances from, and having different alignments with respect to, the activation part.

In the case of an overhead conveyor, it is also possible to provide a movement apparatus in the form of a comb with tines which project upwards from the bottom or project downwards from the top, in particular flexible tines, and this has the same effect as the bar mentioned above. An identical arrangement is also possible on a conveyor belt, in which case the objects which are moving on the conveyor belt are moved to different orientations/positions, with them being bent, by, for example, fingers which engage flexibly in the transport, and their distances from one another can be varied to different extents depending on the object weight and coefficient of friction using the same method.

The variant of a movement which is once again more deliberate can be achieved, for example, by a gripping arm which deliberately grips the respective object moving past the activation part and either causes it move to and fro or to be moved to a different position. The gripping arm can also be used to grip and rotate a transportation box which, as mentioned above, is filled with relatively small objects to be identified.

A movement which is once again arbitrary can be achieved by a shaking apparatus in the form of rollers which are arranged under a conveyor belt and are pressed against it in such a way that the conveyor belt bulges upwards slightly in the area of the roller parts, thus resulting in an uneven conveyor belt section there, over which the moving objects are transported such that they are shaken slightly, and are thus caused to move and to change their alignment.

As an alternative to the movement of the transported objects relative to the identification apparatus, the identification apparatus, in particular the activation apparatus, can also itself be moved, and in particular can be rotated, such that it detects the objects moving past it at respectively different alignment angles.

Yet another option for the design of the variation device is for the activation part to be provided in the form of a plurality of transmitting antennas, in particular two or three different transmitting antennas, with correspondingly mutually different alignments of the associated electromagnetic field, so that the object which is moving past it in each case successively enters the area of a different transmitting antenna having a correspondingly different electromagnetic field alignment with respect to the object. In this case, it is assumed that one of the plurality of antennas will have a suitable alignment and will cause the transmitting part to transmit the code radio frequency signal in an appropriate suitable form.

A further option for a variation device is to provide a vertical step, for example, in the movement path of a conveyor belt, preferably downwards in the direction of the movement path, so that the respective object is forced to change its orientation.

The dimensions of the vertical step must, of course, in this case be matched to the transported items to be expected.

According to another development of the invention, at least one fan is provided as the variation device and is designed and arranged in such a way that the air flow which is produced by the fan and acts on the object causes the orientation of the object to change. This development is particularly advantageous in the textile field since this makes it possible to change orientation of the object without making contact with it, so that, for example, any dirt which is adhering to the variation device is not transferred to the object, in particular to a textile object.

According to one embodiment of the invention, the transport apparatus has two conveyor belts which are arranged at a distance from one another in the feed direction, with the variation device being provided in the gap between the two conveyor belts in the form of a rotating plate, to which objects can be transported from one conveyor belt in order then to be transported by the rotating plate in a rotating manner to the other conveyor belt.

According to another embodiment of the invention, the variation device has a flexible lug which engages, hanging vertically, in the conveying path of the transport apparatus, so that objects which strike this are themselves moved, with the lug being deflected elastically. The lug is preferably designed such that it runs obliquely on its side facing the transport apparatus, in order to cause the object to be rotated in a deliberate direction about its vertical axis.

According to another embodiment of the invention, the variation device has a flap which engages in the transport path of the transport apparatus and can be deflected resiliently elastically in the direction of the transport path of the transport apparatus. In consequence, transported objects which strike against the flap are moved by it, and the flap is in this way itself deflected in a resiliently stressed form.

According to a further embodiment of the invention, the variation device has pairs of rollers which are arranged one behind the other forming a transport path, wherein the rollers of the roller pairs which are arranged on one side with respect to the longitudinal direction of the transport path are driven such that they rotate quicker than the rollers in the roller pairs which are arranged on the other side. The different rotation speeds result in corresponding rotation of objects which are resting on the roller pairs, while being transported over the roller pairs.

According to another embodiment of the invention, the transport apparatus is an overhead conveyor with sacks transported hanging on it, wherein the variation device has a body which projects into the movement path of the sacks. The sacks can themselves each be used as objects to be identified, which are provided with a respective transmitting part. Objects to be identified individually can also be arranged in each of the sacks, and are then each provided with a transmitting part. The deflection of the respective sack results in the sack and the objects which are located in the sack being moved to different positions with respect to the identification apparatus, thus increasing the identification confidence.

According to yet another embodiment of the invention, the variation device is formed by a deflection path section of the transport apparatus, in which the transported objects are transported in the direction which differs from the path sections which run adjacent to it. Normally, the transport apparatus runs essentially in a straight line; in contrast, this deflection path section may have a curved shape, a corrugated shape, a zig-zag shape, etc. In consequence, the objects which are moving in the deflection path section are arranged with their transmitting parts that are fitted to them in different angular positions with respect to the identification device, in order to be detected more reliably.

### BRIEF DESCRIPTION OF THE DRAWINGS

The invention will be explained in more detail in the following text using preferred embodiments and with reference to the attached drawing, in which:

FIG. 1 shows a first embodiment of an identification system according to the invention for identification of objects, in the form of a perspective view,

FIG. 2 shows an identification system for identification of objects according to a second embodiment of the invention, in the form of a view from the front,

FIG. 3 shows a plan view of the identification system shown in FIG. 2,

FIG. 4 shows an identification system for identification of objects, according to a third embodiment of the invention, in the form of a perspective view,

FIG. 5 shows an identification system for identification of objects, according to a fourth embodiment of the invention, in the form of a view from the side,

FIG. 6 shows an identification system for identification of objects, according to a fifth embodiment of the invention, in the form of a view from the side,

FIG. 7 shows an identification system for identification of objects, according to a sixth embodiment of the invention, in the form of a perspective view,

FIG. 8 shows an identification system for identification of objects, according to a seventh embodiment of the invention, in the form of a view from the front,

FIG. 9 shows an identification system for identification of objects, according to an eighth embodiment of the invention, in the form of a perspective view,

FIGS. 10a and 10b show an identification system for identification of objects, according to a ninth embodiment of the invention, in the form of a view from the front and of a view from above, respectively,

FIG. 11 shows an identification system for identification of objects, according to a tenth embodiment of the invention, in the form of a view from above,

FIG. 12 shows an identification system for identification of objects, according to an eleventh embodiment of the invention, in the form of a view from above,

FIGS. 13a, 13b and 13c show an identification system for identification of objects, according to a twelfth embodiment of the invention, in the form of a view from the side, from above and in the form of a section view, respectively,

FIGS. 14, 15 and 16 each show an identification system for identification of objects according to a thirteenth, a fourteenth and a fifteenth embodiment, respectively, of the invention, in the form of a view from above.

Wherever possible, the same reference symbols are used for identical features in the drawing.

### DETAILED DESCRIPTION OF THE PREFERRED EMBODIMENTS OF THE INVENTION

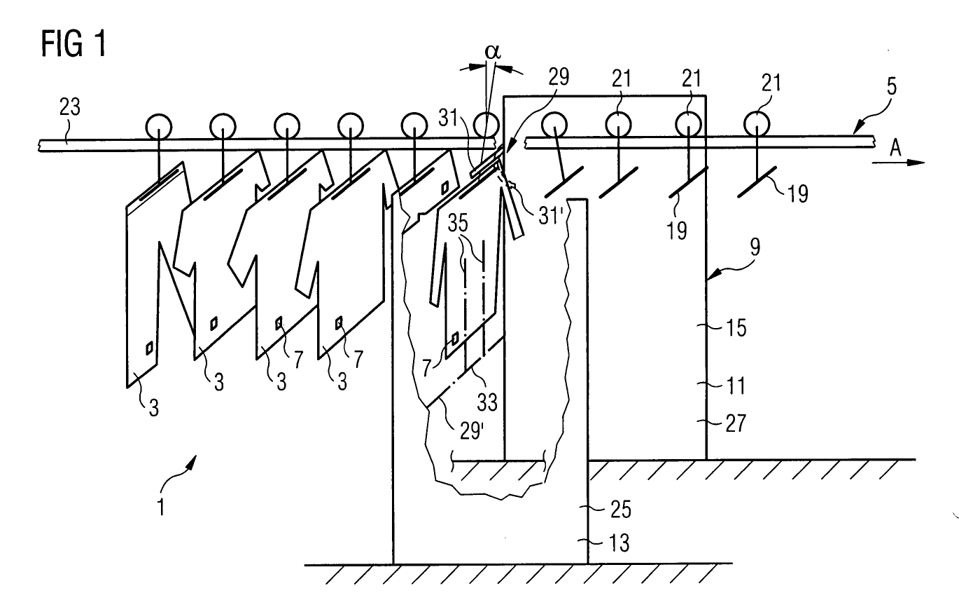

The identification system 1 that is illustrated in FIG. 1 is designed to identify objects 3 in the form of items of clothing, which are continuously conveyed or transported by a transport apparatus 5, which is associated with the identification system 1 and is in the form of an overhead conveyor apparatus, in particular as in a sorting installation at a clothing manufacturer's premises or at a clothing dispatch center.

The identification system 1 has, arranged on each of the objects 3, a transmitting part 7 in the form of an RFID transponder which is additionally fitted to the object or is integrated in it. In this embodiment, the transmitting part 7 is the form of a passive transponder and has a coil, which is used as an energy receiving antenna and transmitting antenna, coupled to a microchip (not illustrated) which stores an identification code. The identification code is preferably unique throughout the world and thus unambiguously identifies the RFID transponder, and hence the object to which the RFID transponder is fitted.

Furthermore, the identification system 1 has an identification apparatus 9 with two panels 11 and 13 which are positioned upright on the base and are arranged at a distance from one another and opposite one another such that an identification corridor 15 is cut out between them, through which the transport apparatus 5 extends, so that the objects 3 are passed continuously through the identification corridor 15 between the two panels 11, 13.

The objects 3 are in this case suspended on hangers 19, which are fitted in an articulated form to trolleys 21, which are illustrated in a simplified form and are themselves guided on a guide rail 23 in the transport apparatus 5, powered by motors.

A gate transmitting antenna (not illustrated) is arranged in the first panel 13 and can be used to transmit an activation radio frequency signal via a wire-free connection to the transmitting part 7, which is passed through the identification corridor 15 together with the respective object 3. The respective transmitting part 7 receives the necessary operating energy from the activation radio frequency signal, and is also caused by the associated activation information to transmit the code radio frequency signal that is stored in the microchip, or to produce the code radio frequency signal from a code which is stored in the microchip and to transmit it, with this code representing the identification information associated with the transported object. The panel 13 together with the gate transmitting antenna that is accommodated in it forms an activation part 25 of this identification system 1.

A gate receiving antenna (not illustrated) is accommodated in the opposite panel 11 as a result of which the panel 11 together with the gate receiving antenna forms a receiving part 27, at which the associated code radio frequency signal transmitted from the respective transmitting part 7 is received via a wire-free connection.

The embodiment of the identification system 1 as shown in FIG. 1 also has a variation device 29, which is arranged adjacent to the activation part 25 and is in the form of a flexibly deflectable bar 31, which is attached (upstream in the transport direction annotated by the arrow A) to the end face of the panel 11 which is associated with the receiving part 27 and engages like a claw at the same level as the hangers 19 in the movement path or transport path of the objects 3, thus forming an obstruction for the hangers 19.

The hangers 19 which (together with the objects 3 that are suspended on them, in this case items of clothing) are moved in the direction of the arrow A by the transport apparatus 5, thus come into contact on the upstream side of the identification apparatus 9 with the bar 31 of the variation device 29 and are thus deflected by this bar 31 through an angle α in the opposite direction to the movement direction A. The elastic bar 31 is in consequence itself elastically deflected to the position 31′ shown by dashed lines in order in the end in this way to allow the hanger 19, with the item of clothing suspended on it, to pass by it. This obstruction process transfers a swinging movement, which is not precisely defined, to the object 3 and to the transmitting part 7 connected to it, as a result of which the distance between the objects 3 successively moving past the activation part 25 is varied, as is the relative alignment between the electromagnetic field which defines the activation radio frequency signal and originates from the activation part 25, and the respective object 3 moving past the activation part 25.

This reduces to virtually zero the probability, which is low in any case, of the identification apparatus 9 not being able to unambiguously identify as a respective transmitting part a badly aligned transmitting part 7 or two transmitting parts which are too close to one another.

As an alternative to the bar 31 which is arranged relatively well upwards in the movement path, FIG. 1 shows a different embodiment of a variation device in the form of dashed-dotted lines, which is in this case annotated with reference symbol 29′. In this case, a comb 33 is provided as the variation device 29′ and is fitted at the end to the panels 11, 13 at the upstream end face of the identification apparatus 9 and is equipped with two comb tines 35 which extend vertically upwards, engage transversely in the movement path A of the objects 3, and thus deflect them in an essentially uncontrolled manner and cause them to carry out swinging and fluttering movements, thus resulting in the same effect as explained above in conjunction with the deflection of the hangers 19.

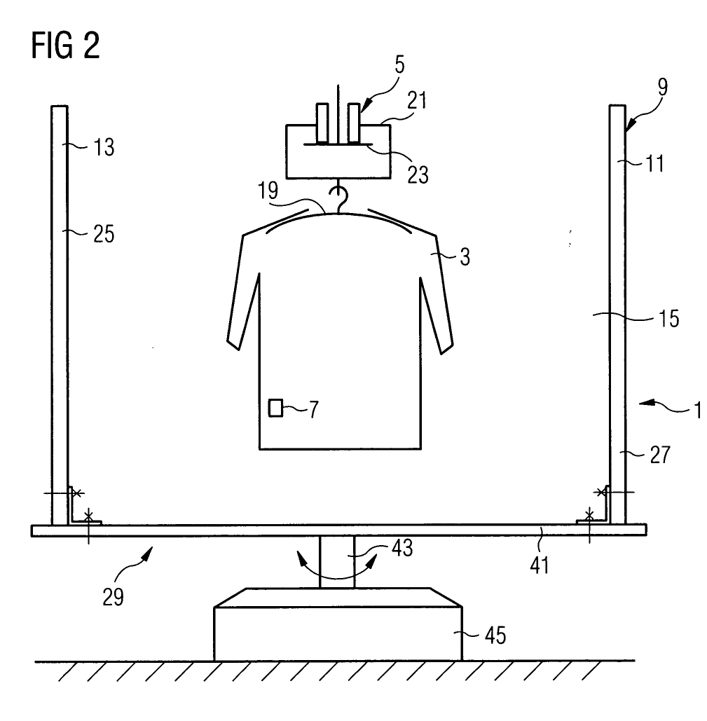

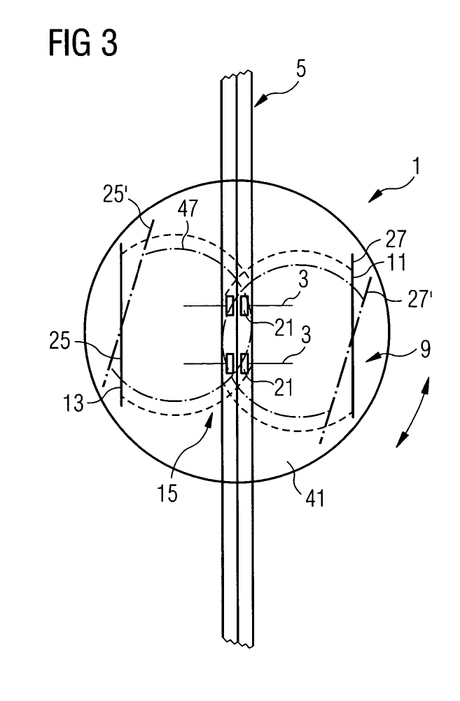

FIG. 2 shows another embodiment of an identification system 1 for identification of objects 3 according to the invention, in the form of a front view, and FIG. 3 shows the associated view of this from above.

This identification system 1 also has a transport apparatus 5 in the form of an overhead conveyor with trolleys 21 which can be moved guided along a guide rail 23.

The objects 3, in this case likewise items of clothing, are once again suspended on hangers 19 which are themselves suspended on the trolleys 21.

As in the embodiment shown in FIG. 1, in this second embodiment as well, the transport apparatus 5 passes through an identification corridor 15 which is formed by an identification apparatus 9 and extends between two panels 11, 13 which are arranged opposite one another and at a distance from one another and of which the first panel 13 has a gate transmitting antenna (not illustrated) forming an activation part 25, and the other panel 11 has a gate receiving antenna forming a receiving part 27. The two antennas and thus the activation part 25 and the receiving part 27 are connected to an electronic control apparatus (not illustrated) which can produce the activation radio frequency signal to be transmitted via the activation part 25 and can supply this to the activation part 25, and/or can process and evaluate the code radio frequency signal which is received by the receiving part 27.

As in the first embodiment, the respective objects 3 are provided with a transmitting part 7 from which, stimulated by the activation radio frequency signal which is transmitted by the activation part 25, the code radio frequency signal is produced and transmitted, with the transmitting part 7 preferably being a passive transmitting part in this case as well, which receives its transmission energy via the activation radio frequency signal which originates from the activation part 25. The code radio frequency signal which is transmitted from the transmitting part 7 is then detected by the gate receiving antenna (which is accommodated in the panel 11) of the receiving part 27 and, as explained above, is transmitted back to the control apparatus, in order to be evaluated by it for identification of the object 3.

In this embodiment, the receiving part 27 and the activation part 25 are mounted on a platform 41, which is firmly connected to a vertically running rotating shaft 43 of an electric motor 45, so that it can be rotated at the same time horizontally by the rotating shaft 43.

The electric motor 45 is likewise connected to the control apparatus (not illustrated), and is driven by the control apparatus in such a way that the motor 45 rotates the platform 41 to and fro in a continuous pivoting movement, for example through an angle of 15 to 30 degrees. As can be seen from FIG. 3, the panels 11, 13 are mounted on the platform 41 and thus the activation part 25 and/or the receiving part 27 are moved to and fro in a pivoting movement as can be seen, for example, on the basis of the position shown by dash-dotted lines 25′, 27′ in FIG. 3.

This results in the alignment of the electromagnetic field 47 that is associated with the activation part 25 being varied with respect to the unchanged alignment of the object 3, and thus in a variation in the relative alignment between the electromagnetic field 47 which defines the activation radio frequency signal and the transmitting part 7 which is fitted to the object 3. The transmitting part 7 is detected in an alignment by the electromagnetic field 47, as is required for reliable activation and subsequent identification of the transmitting part 7 and of the object 3 which is connected to it.

Since, in this embodiment, the distances between the objects are not varied, care should be taken to ensure, however, that the transport apparatus 5 ensures the minimum separation required by the identification apparatus 9 between the objects 3 and thus the transmitting parts 7.

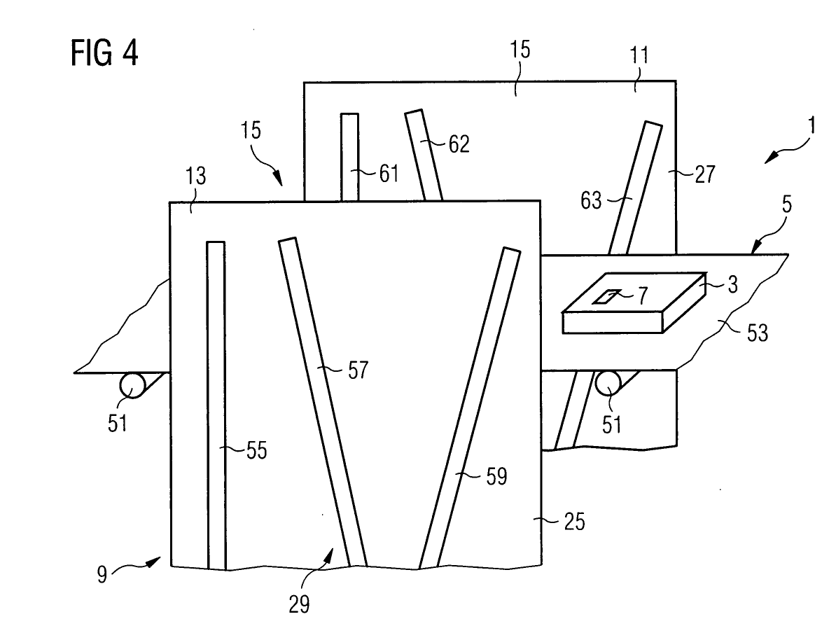

FIG. 4 shows yet another embodiment of an identification system 1 according to the invention for identification of objects 3, which has a transport apparatus 5 in the form of a conveyor belt 53 which moves on rollers 51.

The conveyor belt 53 is passed through an identification corridor 15 that is formed between two panels 11, 13 of an identification apparatus 9.

Three gate transmitting antennas 55, 57, 59, in the form of rods, are arranged at a distance from one another and otherwise located approximately on the same vertical plane, forming an activation part 25 in the movement direction of the conveyor belt 53, with the first transmitting antenna 55 running essentially vertically, the next transmitting antenna 57 running inclined at an angle to the vertical, and the final transmitting antenna 59 running obliquely at an angle to the vertical that is inclined in the opposite sense to that of the second transmitting antenna 57. The activation part 25 and the receiving part 27 form an identification apparatus 9 with an identification corridor 15 between them.

Correspondingly arranged gate receiving antennas 61, 62, 63 are provided in the opposite panel 11, in each case opposite the gate transmitting antennas 55, 57, 59, forming a receiving part 27.

The different antenna alignments in each case result in correspondingly differently aligned electromagnetic fields, so that the objects 3 which are passing through the identification corridor 15, and thus also the transmitting parts 7 associated with these objects 3, are passed successively through the electromagnetic fields (which are aligned differently with respect to them) of the transmitting and receiving antennas.

One of the plurality of differently aligned gate transmitting antennas will be aligned in a suitable manner with respect to the respective transmitting part 7 on the object 3 moving past in order to make it possible to adequately record the signal energy which is required for identification and for operation of the transmitting part 7.

The transmitting and receiving antennas 55-63 are connected to a control apparatus (not illustrated) which provides the drive for the antennas and carries out the processing of the received signals.

FIG. 5 shows yet another embodiment of an identification system 1 for identification of objects 3, by which the objects 3 can be moved by means of an overhead conveyor apparatus 5 past an identification apparatus 9, which has an activation part 25 with a gate transmitting antenna (not illustrated) for transmission of an activation radio frequency signal for activation of transmitting parts 7 which are fitted to the objects 3.

This system 1 has a variation device 29 in the form of a stop apparatus 64, which has an engagement arm 65 which, driven by a motor 66, can engage transversely in the movement path of trolleys 21 which are guided on the overhead conveyor apparatus 5, in order to temporarily prevent the trolleys 21 from moving further. During this process, sensors such as cameras (not illustrated) are used to monitor the distance between successive trolleys 21 and, if the distance is less the minimum separation required for correct identification between successive objects 3, the next trolley 21 is temporarily impeded from being transported any further. Appropriate decoupling capabilities must, of course, be provided for this purpose in the transport apparatus 5, allowing the respective trolley to be decoupled temporarily from the feed apparatus of the transport apparatus 5. One possible way to do this would be to decouple the respective trolley 21 to be stopped by means of a switch from the transport path into a stop path or bypass path, and then to be coupled back onto the transport path again from this stop path or bypass path once a certain holding time has elapsed.

This makes it possible to reliably comply with minimum separations. In this embodiment, the variation device 29 is preferably arranged adjacent to and upstream of the activation part 25.

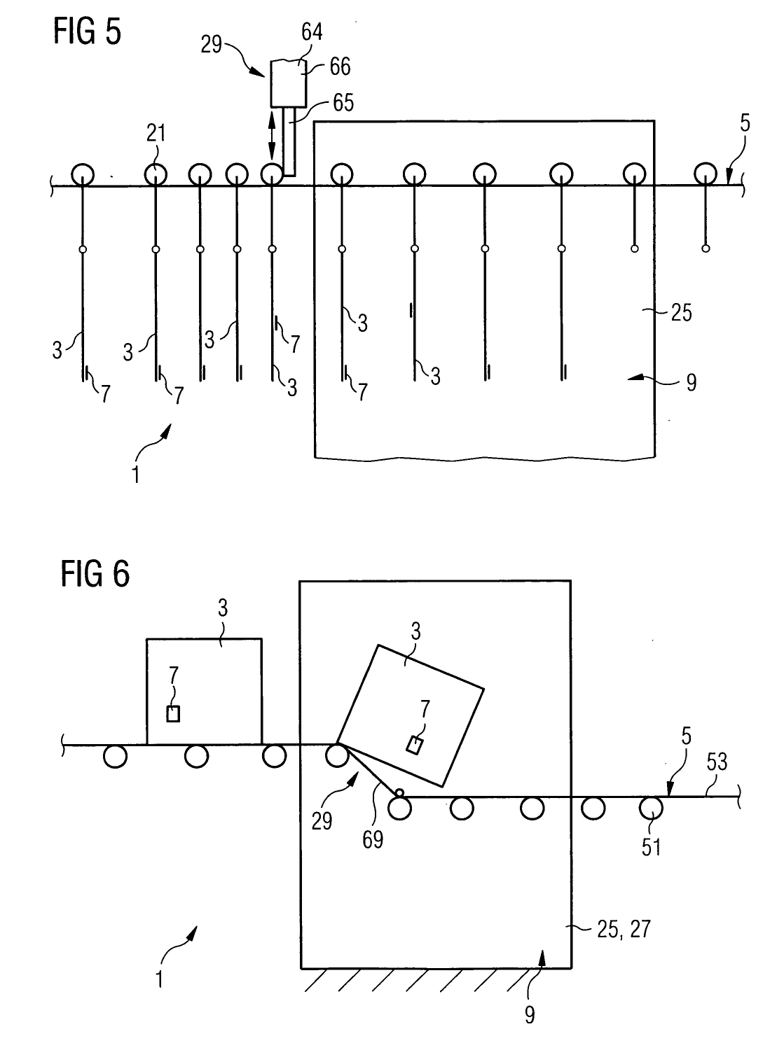

FIG. 6 shows a further embodiment of the identification system 1 according to the invention in which objects 3 to be identified are transported with transmitting parts 7 fitted to them by a transport apparatus 5 which is formed by a conveyor belt 53 that is guided by rollers 51.

The conveyor belt 53 moves past an identification apparatus 9 which is configured as an activation part/receiving part unit, in the form of panels, with an activation part 25 with a gate transmitting antenna and a receiving part 27 with a gate receiving antenna.

A vertical step 69 is provided in the transport apparatus 5 in the region of the transmission area of the activation part 25, so that the objects 3 which are being conveyed on the conveyor belt 53 experience a change in orientation and/or position by sliding down and/or by being tilted, thus varying their distance from the previous and/or subsequent object 3 and their relative alignment with respect to the activation part 25, and hence with respect to the electromagnetic field which is defined by the relative alignment.

This also ensures, in an essentially uncontrolled form, that the transmitting part 7 comes to rest with a different alignment with respect to, and at different distances from, the previous and subsequent transmitting parts with respect to the activation part 25 in order in this way to ensure the highest possible probability of achieving a position which is suitable for correct identification. The step 69 forms the variation device 29.

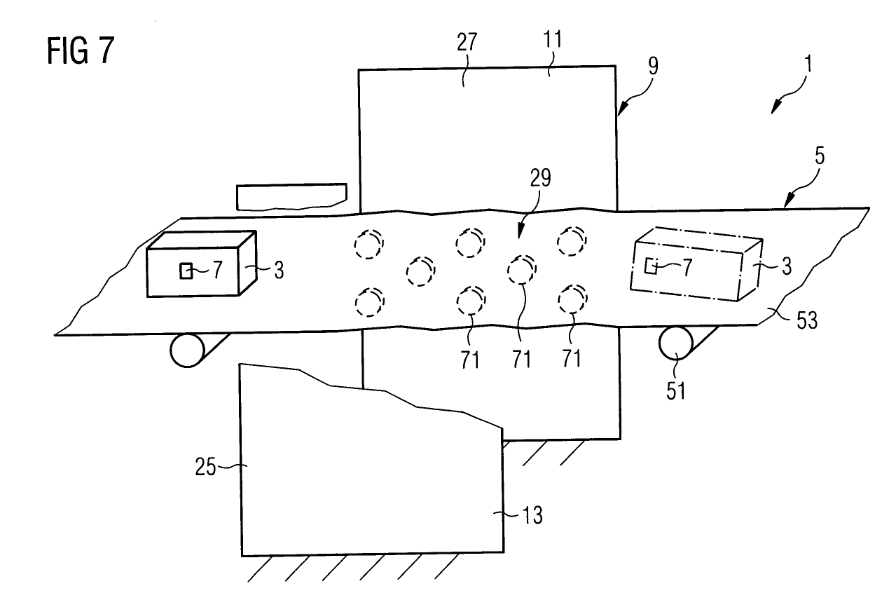

FIG. 7 illustrates yet another exemplary embodiment of the invention. The identification system 1 there has an identification apparatus 9 in the form of two mutually opposite panels 11, 13, in which a gate transmitting antenna (not illustrated) and a gate receiving antenna (not illustrated) are accommodated, so that they respectively form an activation part 25 and a receiving part 27, between which a transport apparatus 5 passes, in the form of a conveyor belt 53 which is guided on rollers 51. The conveyor belt 53 moves objects 3 to which transmitting parts 7 in the form of transponders are fitted. A plurality of roller bodies 71, which are arranged at irregular intervals from one another, are arranged under the conveyor belt 53 in the area between the activation part 25 and the receiving part 27 such that the roller bodies 71 can rotate and in each case make contact with the lower face of the conveyor belt 53 in such a way that the conveyor belt 53 bulges upwards slightly at these contact points. This results in an uneven surface in this contact area between the activation part 25 and the receiving part 27, which means that the objects 3 being transported over this surface are shaken slightly, and their positions, orientations and distances from one another may be varied. The arrangement of the roller bodies 71 engaging with the conveyor belt 53 thus represent a variation device 29 for the purposes of the invention.

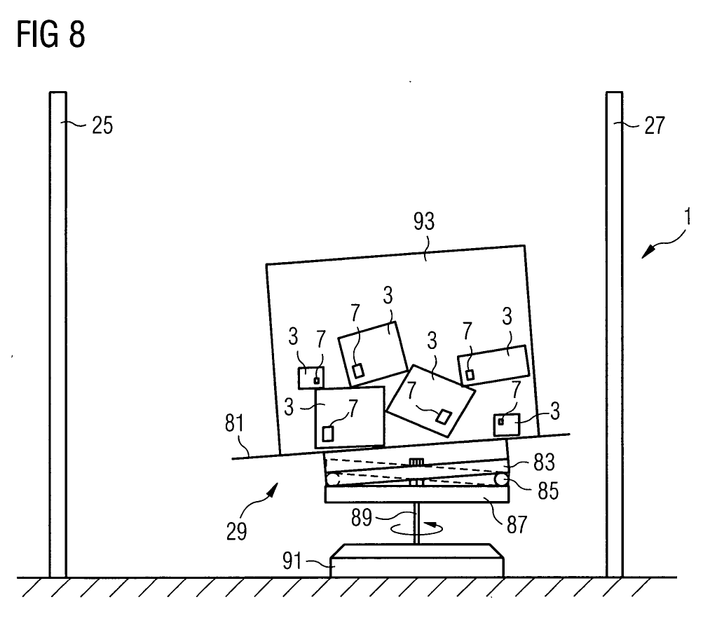

FIG. 8 illustrates a further embodiment of the invention, according to which the identification system 1 has an identification apparatus 9 with an activation part 25 in the form of a gate transmitting antenna, in the form of a rod, for transmission of an activation radio frequency signal, and has a receiving part 27, which is arranged at a distance from the activation part 25 and is in the form of a gate receiving antenna, in the form of a rod, for reception of a code radio frequency signal. A variation device 29 is arranged between the activation part 25 and the receiving part 27 and has a tumbler plate 81 which can be moved with a tumbling action by a tumbler drive. The tumbler drive has a tumbler disk 83 which is attached to the lower face of the tumbler plate 81 and, under the tumbler disk 83, a ball 85 which makes a rolling contact with the tumbler disk 83 and is moved in a circular shape on a horizontal plane so that the tumbler disk 83 is positioned obliquely such that the tumbler disk 83 revolves while carrying out a tumbling movement (see, for example, the position of the tumbler disk 83 illustrated by dashed lines). The ball 85 is fitted on a rotating disk 87 such that it can rotate in order to carry out this rotary movement, and the rotating disk 87 is attached to the rotating shaft 89 of a motor 91 such that they rotate together.

In this identification system 1, provision is made for relatively large containers 93, which are loaded with objects 3 to be identified, to be placed on the tumbler plate 81 in order to make it possible to shake the container 93 by the tumbling movement which can be carried out, as a result of which the objects 3 located in the container 93 can be moved to different positions and to different distances relative to one another and relative to the activation part 25. In consequence, the transmitting parts 7 which are fitted to the objects 3 are also moved to different positions relative to the activation part 25 and to different distances from one another. This results in the greatest possible probability of all of the objects that are located in the container 93 being identified correctly.

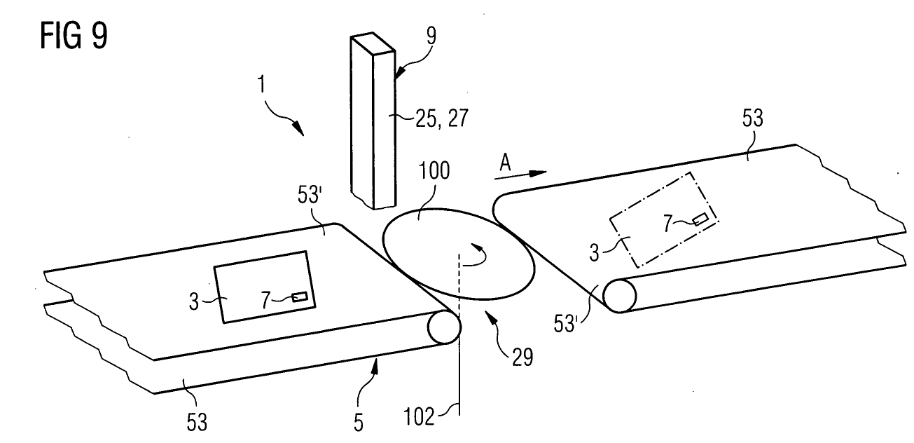

FIG. 9 shows another embodiment of the invention, according to which an identification system 1 has an identification apparatus 9 in the form of a gate transmitting/receiving antenna in the form of a rod, which thus integrally forms both an activation part 25 and a receiving part 27. The identification system 1 also has a transport apparatus 5 in the form of two conveyor belts 53 for transportation of the objects 3 which are equipped with transmitting parts 7, which conveyor belts 53 are arranged with respect to the conveyor belt ends 53′ adjacent to the identification apparatus 9 and at a distance from one another, and are essentially aligned with one another in the movement direction illustrated by the arrow A. A variation device 29 is arranged in the area between the two conveyor belt ends 53′, is in the form of a rotating plate 100 which can be rotated horizontally, is located approximately at the same height as the conveyor belts 53, and is rotated continuously via a shaft 102 by a motor (not illustrated). The rotating plate 100 has a diameter such that it virtually bridges the space between the conveyor belt ends 53′, so that the objects 3 are fed from the conveyor belt 53 on the upstream side of the rotating plate 100 onto the rotating plate 100 and are then moved, as a consequence of rotary movement of this rotating plate 100, onto the subsequent conveyor belt 53, and are then carried away by the latter in the movement direction of the arrow A.

The rotation of the respective object 3 produced by means of the rotating plate 100 also results in its transmitting part 7 being moved to different angular positions with respect to the identification apparatus 9, so that the effects described above in terms of improved identification are achieved.

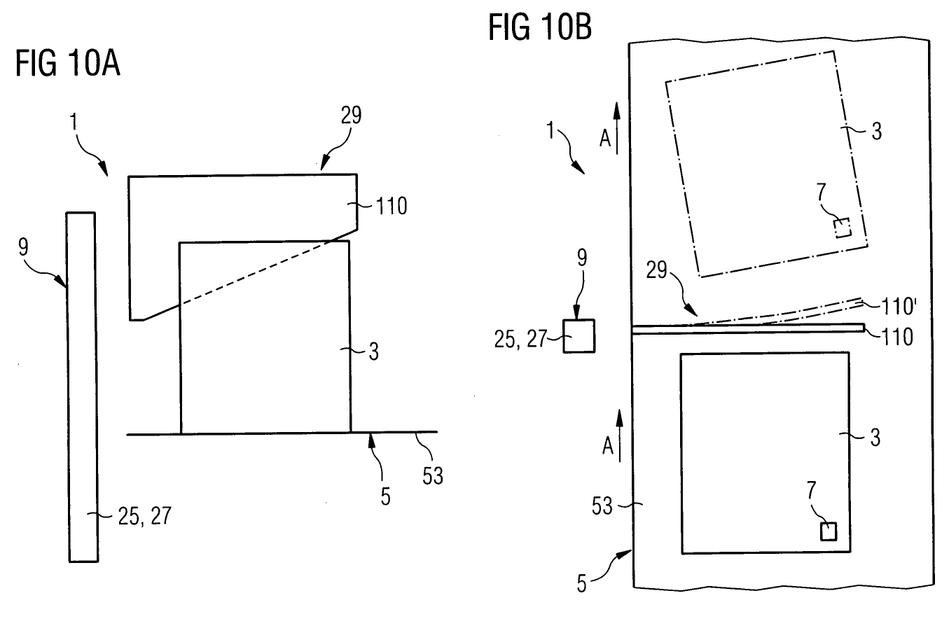

Yet another embodiment of an identification system according to the invention is illustrated in FIGS. 10a and 10b, respectively in the form of a view from the front and a view from above. According to this embodiment, the identification system 1 has an identification apparatus 9 in the form of a transmitting/receiving antenna in the form of a rod, in which the activation part 25 and the receiving part 27 are integrated. The system 1 furthermore has a transport apparatus 5 in the form of a conveyor belt 53, which is moved past the identification apparatus 9. A variation device 29 in the form of a thin, flexible lug part 110 composed of rubber, which extends transversely over the conveyor belt 53 and engages in a suspended form in the conveying path, is provided adjacent to the identification apparatus 9. The lug part 110 is designed such that it runs obliquely with respect to the horizontal at its edge facing the conveyor belt 53. When an object 3 which is provided with a transmitting part 7 is transported on the conveyor belt 53 in the direction of the arrow A, the object 3 strikes against the lug part 110, which engages in the conveying path and is then deflected by virtue of the lug part's 110 elasticity, as can be seen from the dashed-dotted position 110′ of the lug part. Since that edge of the lug part 110 which faces the conveyor belt 53 runs obliquely, the engagement between the object 3 and the lug part 110 continues for longer on that section of the oblique edge which points further downward than on its section which is located at a higher level. In consequence, the object 3 and thus the transmitting part 7 that is fitted to it in FIG. 10b is rotated in the counterclockwise direction, thus achieving the effects described above with regard to reliable identification of the object. The lug part 110 may also have a plurality of vertical slots, forming strips which run vertically and parallel.

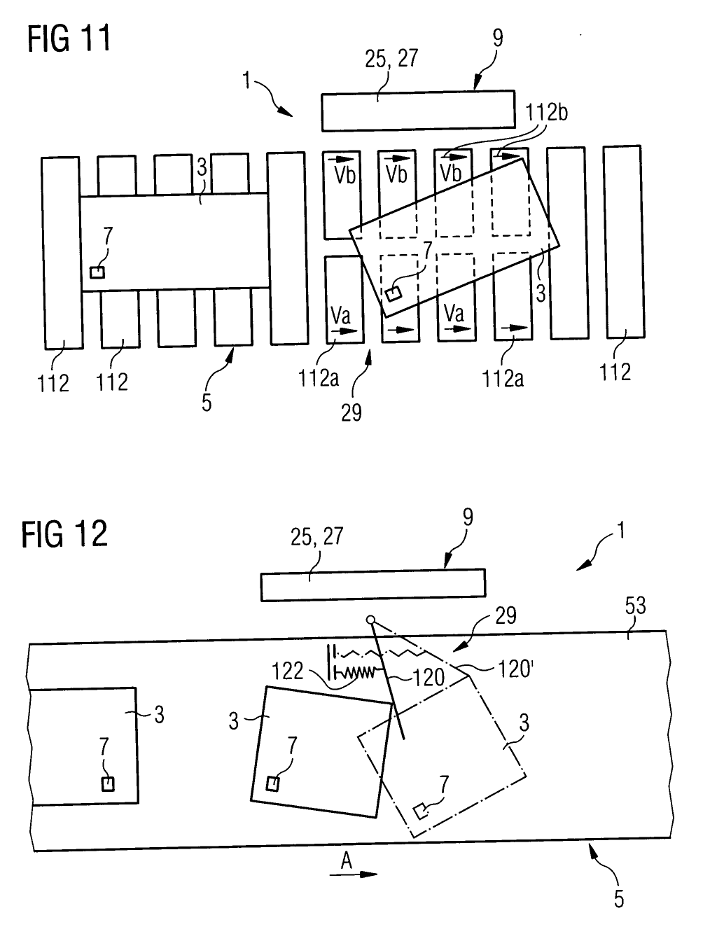

FIG. 11 shows a further embodiment of an identification system 1 according to the invention, viewed from above. This system 1 has an identification apparatus 9 in the form of a transmitting/receiving antenna, which is in the form of a panel and in which an activation part 25 and a receiving part 27 are integrated. The system 1 has a transport apparatus 5 in the form of a roller conveyor with rollers 112 which are arranged one behind the other and at least some of which are driven, with the conveying path passing the identification apparatus 9. Roller pairs 112a, 112b are arranged one behind the other in the feed direction of the roller conveyor adjacent to the identification apparatus 9, and are provided essentially symmetrically with respect to the longitudinal center of the roller conveyor. Those rollers 112a of the roller pairs 112a, 112b which are on the one side can be driven with reference to the longitudinal center of the roller conveyor at a speed Va which is greater than the speed Vb at which those rollers 112b of the roller pairs 112a, 112b which are on the other side can be driven.

In consequence, an object 3 which is being transported past the identification apparatus 9 by the roller conveyor, and thus the transmitting part 7 which is fitted to it, are rotated in the counterclockwise direction by the roller pairs 112a, 112b in FIG. 11 in the area of the identification apparatus 9. This achieves the effects described above for reliable identification of the objects. The differently driven roller pairs 112a, 112b in this case form the variation device 29, which can also be provided in conjunction with other transport apparatuses, for example connected between two conveyor belts, or else on its own. In the latter case, objects are, for example, placed directly on the roller pairs and are transported by the roller pairs for only a short distance past the identification apparatus 9, for example to a storage container.

FIG. 12 shows a further embodiment of the invention, viewed from above, according to which the identification system has an identification apparatus 9 in the form of a transmitting/receiving antenna, which is in the form of a panel and in which the activation part 25 and the receiving part 27 are integrated.

The identification system 1 also has a transport apparatus 5 in the form of a conveyor belt 53, to which objects 3 which are provided with a respective transmitting part 7 are transported, and which moves past the identification apparatus 9. A variation device 29 is provided at the same height (seen in the feed direction of the arrow A) as the identification apparatus 9 and has a flap 120, which is in the form of a plate, engages in the conveying path of the conveyor belt 53, can be pivoted about a vertical axis and is attached to a tension spring 122 in such a way that the flap 120 can be deflected in the direction of the conveying path, as indicated by the arrow A, with the tension spring 122 being loaded. The objects 3 which have been transported by the conveyor belt 53 and are provided with transmitting parts 7 strike against the flap 120 which projects into the conveying path. On the one hand, this results in the flap 120 being deflected, for example to its position indicated the dashed-dotted lines 120′, while on the other hand, the opposing force which is produced by the tension spring 122 also moves and rotates the respective object 3 together with the transmitting part 7 fitted to it (in the counterclockwise direction in FIG. 12), for example to the position illustrated by the dashed-dotted line. This achieves the effects explained above for reliable identification of the object 3.

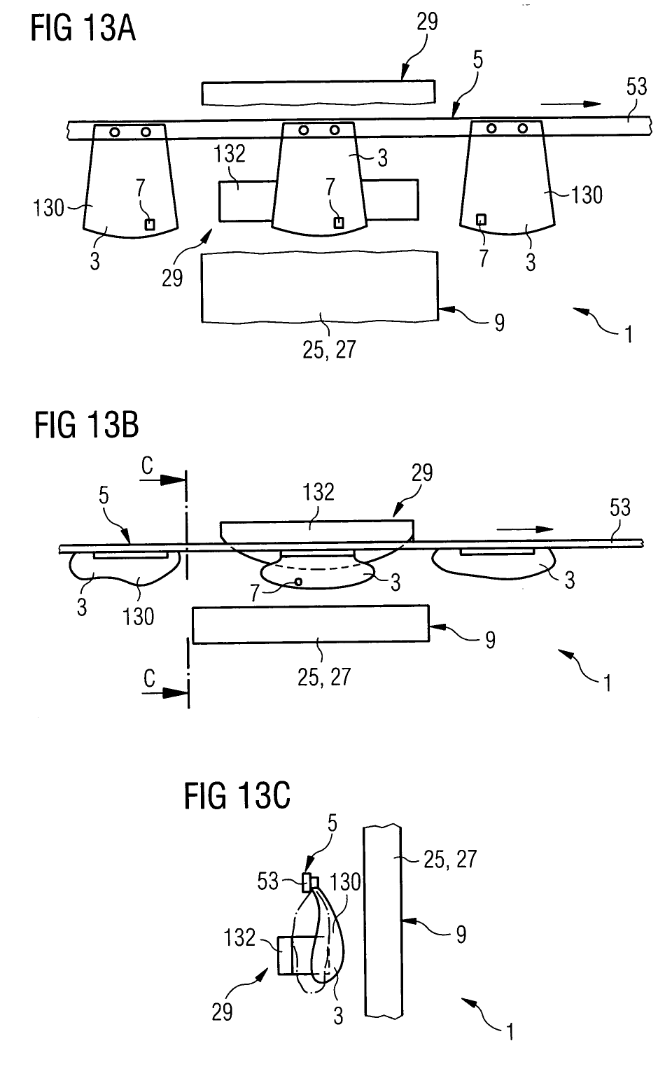

FIGS. 13a, 13b and 13c show yet another embodiment of an identification system 1 according to the invention, viewed from the side, viewed from above, and in the form of a section view among the line C-C in FIG. 13b.

According to these figures, the identification system 1 has an identification apparatus 9 in the form of a transmitting/receiving antenna which is in the form of a panel and has an activation part 25 and a receiving part 27 integrated in it. The system 1 also has a transport apparatus 5 in the form of an overhead conveyor with a conveyor belt 53, which is in the form of a belt or chain and to which sacks 130 which are at regular distances from one another are firmly fitted and can themselves be used as objects 3 to be conveyed, which are provided with transmitting parts 7 and can thus be identified, but which sacks 130 can also contain objects (not illustrated) which are then each provided with transmitting parts 7. The overhead conveyor moves past the identification apparatus 9.

A variation device 29 in the form of a block body part 132 is arranged, for example under the conveyor belt 53, on the opposite side of the conveyor belt 53 towards the identification apparatus 9. The block body part 132 projects somewhat over the conveyor belt 53 from the side in the direction of the identification apparatus 9, so that it engages in the movement path of the sacks 130 which are suspended on the conveyor belt 53, and forms an obstruction. As the sacks 130 move past, the sacks 130 are thus deflected by the block body part 132 from their initial suspended position (illustrated as a dashed-dotted line in FIG. 13c) in the direction of the identification apparatus 9. In consequence, the position and angle of the transmitting part 7 which is fitted to the respective sack 130 changes with respect to the identification apparatus 9, thus resulting in the respective sack 130 being identified more reliably, as explained above. The same applies to the objects (not illustrated) which are arranged in the sack 130 and are likewise deflected by the deflection of the sack 130, while their positions relative to one another in the sack 130 may be changed, so that the associated transmitting parts on these objects experience a position and angle change relative to the identification apparatus 9. In order to prevent the sacks 130 from being damaged as they pass the block body part 132, the block body part 132 is provided with a rounded profile, in the form of a circular arc over the entire face on the side facing the conveyor belt 53.

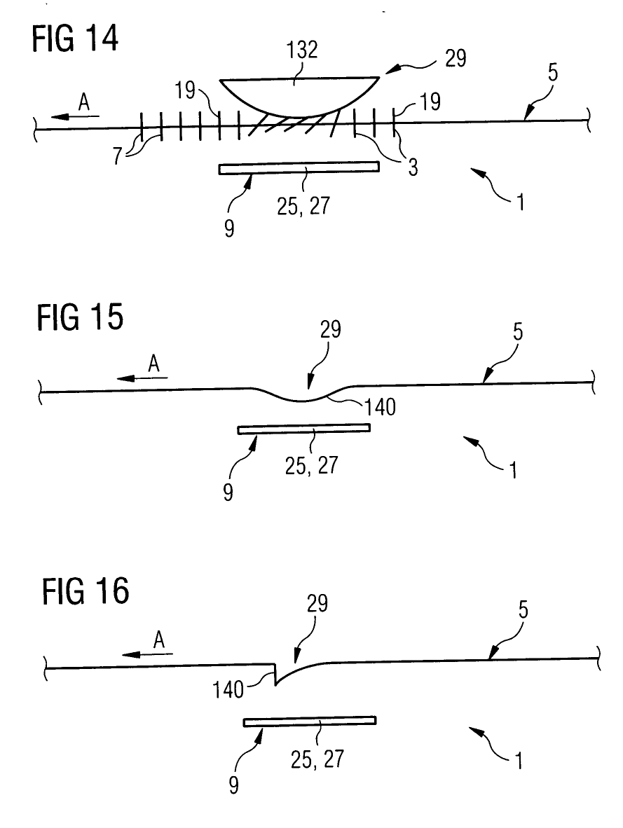

FIG. 14 shows yet another embodiment of the identification system 1 according to the invention, viewed from above. The system 1 has an identification apparatus 9 in the form of a transmitting/receiving antenna, which is in the form of an antenna and has an activation part 25 and a receiving part 27 integrated in it. The system 1 also has a transport apparatus 5 in the form an overhead conveyor installation, which conveys hangers 19, for example coat hangers, in the direction of the arrow A. The transport apparatus 5 moves past the identification apparatus 9. The system 1 has a variation apparatus 29 opposite the identification apparatus 9 with reference to the transport apparatus 5, with this variation apparatus 29 being in the form of a block body part 132 which is designed in the same was as that in the embodiment shown in FIGS. 13a-c and engages in the movement part path of the hangers 19. The hangers which strike the block body part 132 are rotated about a vertical axis in the area of the identification apparatus 9. Objects 3 which are suspended on the hangers 19, for example items of clothing, are thus likewise rotated together with the transmitting parts 7 which are fitted to them, as a result of which the latter are each arranged at different angles with respect to the identification apparatus 9.

This increases the identification reliability, as described above.

FIGS. 15 and 16 show two further embodiments of an identification system 1 according to the invention, viewed from above. According to these figures, the system 1 in each case has an identification apparatus 9 in the form of a transmitting/receiving antenna 25, 27, which is in the form of a panel and has an activation part 25 and a transmitting part 27 integrated in it. The system has a transport apparatus 5, for example a conveyor belt or an overhead conveyor track, which moves past the identification apparatus 9. In both embodiments, a deflection path section 140 is provided as the variation device 29 in the area of the identification apparatus 9 in the transport path of the transport apparatus 5. The deflection path section 140 is altered in shape (e.g. curved, corrugated, zig-zag, etc.) from the normally straight track. Transported objects are guided by the normally straight track along a path which shears away from deflection path section 140 in order to be transported further in the normal manner, in the same way as before the deflection path section 140.

In the exemplary embodiment illustrated in FIG. 15, the deflection path section 140 is curved, in particular in the form of a circular arc. In the exemplary embodiment shown in FIG. 16, the transport path initially shears away slowly in a slightly curved manner in the deflection section 140, in order then to be guided back abruptly to the original transport direction, aligned with the incoming transport path.

The objects (not illustrated) being transported in the direction of the arrow A and the transmitting part (not illustrated) fitted to them thus experience an angle change in the area of the identification apparatus 9 relative to the latter, thus achieving increased identification reliability, as described above.

The identification apparatus has thus been described by way of example on the basis of mutually opposite panels containing antennas. However, in the desired antenna forms, even without such panels, are feasible. For example, a rod antenna or any other antenna may be provided in its own right as the activation part. In addition, the transmitting antenna and the receiving antenna may be provided as one part, so that the activation part and the receiving part thus form a single unit, with this unit then acting as the activation part during transmission of activation radio frequency signals, in order then to be switched to reception, as a result of which it then acts as a receiving part for reception of code radio frequency signals. Furthermore, the respective gate transmitting antenna and the respective gate receiving antenna can be arranged in the same panel, forming an activation part/transmitting part unit, with mutually opposite panels defining an identification corridor between them, whose width depends on the range of the respective activation part/transmitting part unit.

The embodiments mentioned above represent non-restrictive exemplary embodiments of the invention, whose scope of protection is defined by the attached claims. Modifications are accordingly feasible within the scope of the invention without departing from the area of protection of the attached claims.

1-17. (canceled)

18. An identification system for identifying objects, comprising:
a plurality of objects to be identified;
a transmitting part, the transmitting part being fitted to each of the plurality of objects and operable to transmit a code radio frequency signal representing an identification code;
an activation part operable to transmit an activation radio frequency signal via a wire-free connection to the transmitting part of each of the plurality of objects so that the transmitting part transmits the code radio frequency signal;
a receiving part operable to receive the code radio frequency signal via a wire-free connection;
a transport apparatus operable to move a respective object past the activation part; and
a variation device arranged adjacent to the activation part, the variation device operable to vary a relative alignment between an electromagnetic field which defines the activation radio frequency signal and the respective object which is moving past the activation part, as the respective object moves past the activation part.

19. The identification system according to claim 18, further comprising:
a second object adjacent to the respective object at a distance D, wherein the variation device is further operable to move the respective object so that the distance D is equal to or greater than a minimum separation value based on a minimum permissible distance resolution for correct detection of the code radio frequency signal transmitted from adjacent objects

20. The identification system according to claim 18, wherein the variation device comprises a movement apparatus which engages in a transport path of the respective object to cause uncontrolled movement of the respective object as the respective object moves past the activation part.

21. The identification system as claimed in claim 20, wherein the transport apparatus comprises an overhead conveyor which transports the plurality of objects in a suspended form, and the movement apparatus comprises an obstruction arranged adjacent to the activation part in the transport path of the plurality of objects and deflects the plurality of objects.

22. The identification system as claimed in claim 21, wherein the obstruction comprises at least one of a bar which engages transversely in the transport path, a cord which is stretched transversely over the transport path, and a cord arrangement which is stretched transversely over the transport path.

23. The identification system as claimed in claim 20, wherein the transport apparatus comprises a conveyor belt, and the movement apparatus comprises a vertical step in the conveyor belt path, so that when the plurality of objects moving on the conveyor belt pass over the vertical step, the plurality of objects experience a position change.

24. The identification system as claimed in claim 18, wherein the variation device comprises a shaking apparatus arranged adjacent to the activation part so that when the plurality of objects move past the activation part, the shaking apparatus shakes the plurality of objects.

25. The identification system as claimed in claim 24, wherein the transport apparatus comprises a conveyor belt, and the shaking apparatus comprises roller parts which are arranged under the conveyor belt adjacent to the activation part and make a rolling contact with the conveyor belt such that the conveyor belt bulges upwards.

26. The identification system as claimed in claim 18, wherein the variation device comprises a gripping arm arranged adjacent to the activation part which can grip the respective object and move the respective object from a first position to a second position.

27. The identification system as claimed in claim 18, wherein the variation device comprises a tumbler plate on which the respective object is placed to transfer a tumbling movement to the respective object in order to move the respective object.

28. The identification system as claimed in claim 18, wherein the variation device is formed such that the activation part can rotate.

29. The identification system as claimed in claim 18, wherein the transport apparatus comprises a first conveyor belt and a second conveyor belt in a feed direction, the first and second conveyor belts being arranged at a distance from one another in the feed direction, and the variation device comprises a rotating plate positioned in a gap between the first and second conveyor belts so that the respective object can be transported in a rotating manner from the first conveyor belt to the second conveyor belt by the rotating plate.

30. The identification system as claimed in claim 18, wherein the variation device comprises a vertically hanging flexible lug which engages in a conveying path of the transport apparatus.

31. The identification system as claimed in claim 30, wherein the lug runs obliquely on its side facing the transport apparatus.

32. The identification system as claimed in claim 18, wherein the variation device comprises a flap which engages in a transport path of the transport apparatus and can be deflected resiliently in the direction of the transport path of the transport apparatus.

33. The identification system as claimed in claim 18, wherein the variation device comprises:
a plurality of rollers arranged in pairs, the plurality of rollers being arranged one behind the other to form a transport path;
a first roller of one pair arranged on a first side with respect to a longitudinal direction of the transport path; and
a second roller of the pair arranged on a second side of the longitudinal direction of the transport path,
wherein the first and second rollers rotate at different speeds.

34. The identification system as claimed in claim 18, wherein the transport apparatus comprises an overhead conveyor with a sack to be transported hanging on it, and the variation device comprises a body which projects into the movement path of the sack.

35. A method for identifying objects, comprising the steps of:
attaching a transmitter to a first object to be identified;
transporting the first object down a transport path;
transmitting an activation radio frequency signal from an activation part to the transmitter via a wire-free connection;
transmitting, by the transmitter, a code radio frequency signal representing an identification code via a wire-free connection;
receiving the code radio frequency signal via a wire-free connection; and
varying a relative alignment between an electromagnetic field which defines the activation radio frequency signal and the first object, as the first object moves past the activation part.

36. The method of claim 35, further comprising the steps of:
transporting a second object down the transport path at a distance D; and
varying the distance D between the first object and the second object so that the distance D is equal to or greater than a minimum separation value, wherein the minimum separation value is based on a minimum permissible distance resolution for correct detection of the code radio frequency signal transmitted from adjacent objects.

37. An identification system for identifying a plurality of objects, comprising:
means for transmitting a code radio frequency signal representing an identification code, the transmitting means being configured to be coupled to each object;
activation means for transmitting an activation radio frequency signal via a wire-free connection to the transmitting means associated with one object to cause the transmitting means to transmit the code radio frequency signal;
means for receiving the code radio frequency signal via a wire-free connection;
means for transporting one respective object past the activation means; and
means for varying a relative alignment between an electromagnetic field which defines the activation radio frequency signal and the respective object which is moving past the activation means, as the respective object moves past the activation means, the means for varying the alignment being arranged adjacent to the activation means.
